(19) United States
(12) Patent Application Publication
(10) Pub. No.: US 2006/0087231 A1
(43) Pub. Date: Apr. 27, 2006

(54) Self-cleaning area illumination system

(75) Inventors: Ronald S. Cok, Rochester, NY (US); Donald R. Preuss, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/974,249

(22) Filed: Oct. 27, 2004

(51) Int. Cl. H05B 33/04; H05B 33/10

(52) U.S. Cl. 313/512; 313/503; 313/511; 445/25

(57) ABSTRACT

A flat-panel organic light-emitting area illumination lamp, comprising a thin-film organic light-emitting structure comprising a first electrode, one or more organic layers including an organic light-emitting layer, and a second electrode; and a member having a first side and second side, the thin-film organic light-emitting structure disposed adjacent the first side, the second side having self-cleaning surface.

### FIELD OF THE INVENTION

The present invention relates to area illumination and, more particularly, to self-cleaning flat-panel lamps used for area illumination.

### BACKGROUND OF THE INVENTION

Outdoor lamps and other area illumination devices are typically protected from the environment. Most lamps are made of glass and are very hot when operated. If cold rain or snow strikes the glass of the lamp, it is likely that the lamp will shatter. Hence outdoor lighting fixtures typically include a protective housing around the lamp. Such a housing also provides protection from dirt, stones, insects and the like. Referring to FIG. 7, a prior-art common area illumination system includes an incandescent lamp 50 having a screw-type base 52 and electrical connection 54 inserted into a socket 56 and connected to an electrical connector such as a cord 58 with wires and a plug 59 for connection to a power grid (not shown). A housing 61 protects the lamp 50 and a transparent protective glass cover 63 protects the lamp. In some cases, illumination is directed downward and the protective glass cover 63 is omitted and the lamp itself is constructed with heavy, shatter-proof glass. However, such designs utilize inefficient incandescent illumination technology, are essentially a point source of illumination, are very hot, accumulate dust, and are bulky.

In a more complex commercial fixture, other types of lamps may be employed. For example, U.S. Pat. No. 4,768,140 issued Aug. 30, 1988 by Szpur discloses a high-pressure sodium lamp that has a horizontal light source and is supported by a socket and frame which includes a horizontal reflecting plate member positioned below the lamp. A pair of open grid-type reflector panels are supported by the plate member on opposite sides of the lamp and at inclined angles to reflect light rays downwardly while preventing direct viewing of the light source through the panels. The frame is supported below the ceiling of a room, and in one embodiment, a rectangular open bottom and open top translucent shade surrounds the lamp and reflector panels. All light rays emanating from the light source are reflected within the room to produce 100% indirect lighting, and air flows upwardly through the panels and around the lamp to provide for cooling and self-cleaning of the lamp. However, such housings are primarily useful indoors for bulb-type lamps, greatly increase the effective size of the lamp, decrease the light output of the lamp, become dirty and are difficult to clean thereby increasing the temperature of the lamp, decreasing its brightness, and reducing the lifetime of the lamp. Moreover, many such housings are impractical when applied to flat-panel lamps and can greatly increase the effective size of the lamp.

Electroluminescent or EL panels and the like are thin, flat, light-emitting devices that may be employed in area illumination to provide light over a large surface. The light is produced without the high temperatures associated with incandescent and fluorescent light emitting devices. In addition since glass envelopes used for these types of lighting systems are not required for EL lighting systems, they are far less prone to breakage from contact with foreign objects than are conventional incandescent or fluorescent lamps. Electroluminescent (EL) lamps are created by placing a phosphor layer between two electrodes that function electrically as a capacitor. AC voltage is applied across the electrodes and light is generated which passes through a transparent electrode. EL lamps can be as thin as 0.008″, may be flexible, and are shock resistant. Flexible electroluminescent cable, sheets, and ribbons are known and can be cut to size and can include an adhesive mounting layer. Such EL lamps may also be constructed on flat, glass substrates to provide a more rigid, flat-panel structure.

Organic light emitting diodes (OLEDs) are manufactured by depositing organic semiconductor materials between electrodes on a substrate. This process enables the creation of light sources having extended surface area on a single substrate. The prior art describes the use of electro-luminescent materials as adjuncts to conventional lighting (for example U.S. Pat. No. 6,168,282, issued Jan. 2, 2001 to Chien). In this case, because of the limited light output from the electroluminescent material, it is not useful for primary lighting.

Organic light emitting diodes (OLEDs) may be employed to construct flat-panel lamps. It is known to manufacture an OLED light source or display device on a flexible or rigid substrate. See for example EP0949850 A1, published Oct. 13, 1999 that shows a substrate comprising a laminated substrate of plastic and glass. The manufacture of the OLED device on a flexible substrate facilitates continuous manufacture, wherein the substrate can be supplied as a web in a roll.

U.S. Pat. No. 6,776,496 issued Aug. 17, 2004 to Cok discloses a lighting apparatus that includes a solid-state area illumination light source having: a planar substrate, an organic light emitting diode (OLED) layer deposited on the planar substrate, the organic light emitting diode layer including first and second electrodes for providing electrical power to the OLED layer, an encapsulating cover covering the OLED layer, and first and second conductors electrically connected to the first and second electrodes, and extending beyond the encapsulating cover for making electrical contact to the first and second electrodes by an external power source; and a lighting fixture for removably receiving and holding the solid-state light area illumination light source in a horizontal plane, the lighting fixture including contacts for providing electrical contact between said first and second conductors and an external power source. However, such an apparatus is most useful in indoor applications and does not address environmental protection issues.

There is a need, therefore, for an improved, solid-state flat-panel area illumination system providing robust illumination with high brightness, a reduced size, and providing environmental protection.

### SUMMARY OF THE INVENTION

In accordance with one aspect of the present invention there is provided a flat-panel organic light-emitting area illumination lamp comprising a thin-film organic light-emitting structure comprising a first electrode, one or more organic layers including an organic light-emitting layer, and a second electrode and a member having a first side and second side, the thin-film organic light-emitting structure disposed adjacent the first side, the second side having a self-cleaning surface.

### Advantages

The present invention has the advantage of providing a flat-panel area illumination system having high brightness and a reduced size, in particular, for outdoor illumination.

These and other aspects, objects, features and advantages of the present invention will be more clearly understood and appreciated from a review of the following detailed description of the preferred embodiments and appended claims and by reference to the accompanying drawings.

### BRIEF DESCRIPTION OF THE DRAWINGS

In the detailed description of the preferred embodiments of the invention presented below, reference is made to the accompanying drawings in which:

FIG. 1 is a cross section of flat-panel lamp made in accordance with the present invention;

FIG. 2 is a cross section of an alternative embodiment of a flat-panel lamp also made in accordance with the present invention;

FIG. 3 is a cross section of a prior-art flat-panel light emitting device;

FIG. 4 is a cross section of yet another alternative embodiment of a flat-panel lamp made in accordance with the present invention;

FIG. 5 is a cross section of still another alternative embodiment of a flat-panel lamp made in accordance with the present invention;

FIG. 6 is a schematic view of an embodiment of the present invention mounted on a vertical surface; and

FIG. 7 is a cross section of a prior-art area illumination device.

It will be understood that the figures are not to scale since the individual layers are too thin and the thickness differences of various layers too great to permit depiction to scale.

### DETAILED DESCRIPTION OF THE INVENTION

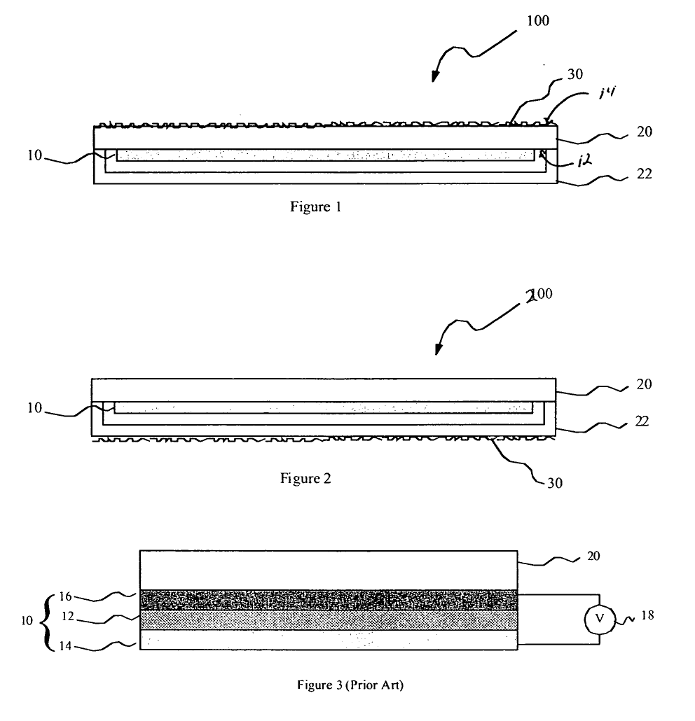

Referring to FIG. 1, there is illustrated a flat-panel area illumination device 100 made in accordance with the present invention. The illumination device 100 comprises a support member 20 having a thin-film light emitting structure 10 adjacent a first side 12, an encapsulating cover 22 located over thin-film light emitting structure 10 and affixed to the first side 12 of the support member 20. A self-cleaning surface 30 is provided on the second side 14 of the support member 20.

There are various known surfaces and materials that may be employed in the present invention for providing self-cleaning surface. For example, but not by way of limitation, U.S. Publication No. 2004/0023798 entitled “MICRO-STRUCTURED, SELF-CLEANING CATALYTICALLY ACTIVATED SURFACE” by Kaibel et al. published Feb. 5, 2004, describes a micro-structured, self-cleaning catalytically active surface with elevations and depressions, comprising a catalytically active material in the depressions and additionally provides a process for producing a micro-structured self-cleaning catalytically active surface and a catalyst molding having such a surface in which a support surface is powder coated with particles having a size of from 0.05 to 200 microns and is subsequently coated with a catalytically active material. U.S. Pat. No. 6,068,911 issued May 30, 2000 by Shouji et al. describes a super water-repellent coating film formed of a super water-repellent coating material comprising an organic coating material composed of organic polymer, a filler mixture composed of plural kinds of fillers of at least 5 nm in average particle diameter, which is dispersed in the coating material, and a perfluoropolyoxyalkyl group compound. Because the surface of various solid bodies can be made super water-repellent by a simple process using this water-repellent coating material, the coating film can be utilized for outdoor area illumination systems. It is also known to use antistatic coatings to prevent dust contamination of surfaces. U.S. Pat. No. 5,539,055 issued Jul. 23, 1996 by Nishimoto et al. claims excellent dust repellancy for treated surfaces.

Means for making micro-structured surfaces are also known. For example, U.S. Pat. No. 6,641,767 B2 issued Nov. 4, 2003 by Zhang, et al. discloses a method of replicating a structured surface that includes providing a tool having a structured surface having a surface morphology of a crystallized vapor deposited material, and replicating the structured surface of the tool to form a replicated article. A replicated article includes at least one replicated surface, wherein the replicated surface includes a replica of a crystallized vapor deposited material. A replication tool includes a tool body that includes a tooling surface, and a structured surface on the tooling surface, wherein the structured surface includes crystallized vapor deposited material or a replica of crystallized vapor deposited material.

The present invention may be manufactured using continuous manufacturing processes including, for example, forming the substrate on a web. Applicants have demonstrated the manufacture of micro-structures suitable for the formation of self-similar, fractal surface in a continuous process. In such a process, the substrate and encapsulating cover are formed separately with a micro-structured surface on one of the sides of either the substrate or encapsulating cover. Additional materials may then be added to the micro-structured surface. An electrode is then deposited upon the other side of the substrate, the electroluminescent layer(s) are then deposited on the electrode, and a second electrode deposited on the electroluminescent layer(s). The assembly is then encapsulated, leaving a connection to the electrodes on the substrate available for external connection.

Although a variety of solid-state, flat-panel light sources are contemplated for thin-film light emitting structure 10 of the present invention, for example electroluminescent light sources, in a preferred embodiment, an organic light emitting diode (OLED) solid-state light source may be employed. Referring to FIG. 3, there is illustrated a prior-art flat-panel OLED light source that can be used as a thin-film light emitting structure 10 in the present invention. The prior-thin-film light emitting structure 10 includes a support member/substrate 62, a first electrode 64 (for example an anode) deposited upon the support member 62, one or more organic layers 66, at least one of which emits light in response to an electrical current, are deposited upon the first electrode 64, and a second electrode 68 (for example, a cathode) is deposited upon the one or more organic layers 66. In a preferred embodiment of the flat-panel area illumination system illustrated in FIG. 1, the support substrate 62 is used as the support member 20. The combination of the electrodes 64 and 68 and the one or more organic layers 66 are referred to as thin-film light emitting structure 10. As shown in FIGS. 1 and 2, the thin-film light emitting structure 10 is encapsulated with an encapsulating cover 22. The support member 20/62 and encapsulating cover 22 may be made either rigid or flexible and made of a variety of materials, for example glass and plastic.

In operation, a voltage 18 is supplied to the first electrode 64 and second electrode 68 to create a current passing through the one or more organic layers 66. The emissive layer emits light in response to the current. At least one of the electrodes 64 and 68 must be transparent for light to be emitted from the thin-film light emitting structure 10. Both first electrode 64 and second electrode 68 may be transparent and, if the encapsulating cover 22 and substrate 20 are also transparent, light is emitted from both sides of the area illumination device 100. If first electrode 64 is opaque or, preferably, reflective, light is emitted through the substrate 20/62, which must be transparent. If second electrode 68 is opaque or, preferably, reflective, light is emitted through the encapsulating cover 22, which must be transparent. Alternatively, one or the other of the electrodes 64 and 68 must be transparent and either the support member 20/62 or encapsulating cover 22 must be reflective.

Referring to FIG. 2, in an alternative embodiment a flat-panel area illumination device 200, like numerals indicating like parts and operation as previously discussed. Flat-panel illumination device 200 comprises a support member 20 having a thin-film light emitting structure 10 constructed on a first side 12, an encapsulating cover 22 located over the flat-panel lamp 10 and affixed to the first side 12 of the support member 20, and self-cleaning surface 30 located on the outside of the encapsulating cover 22.

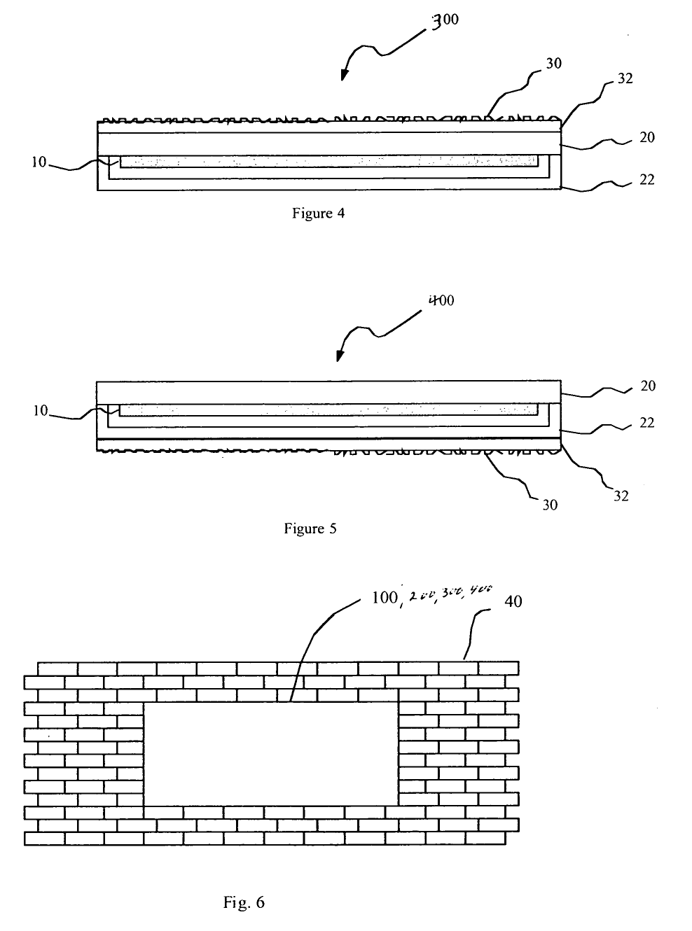

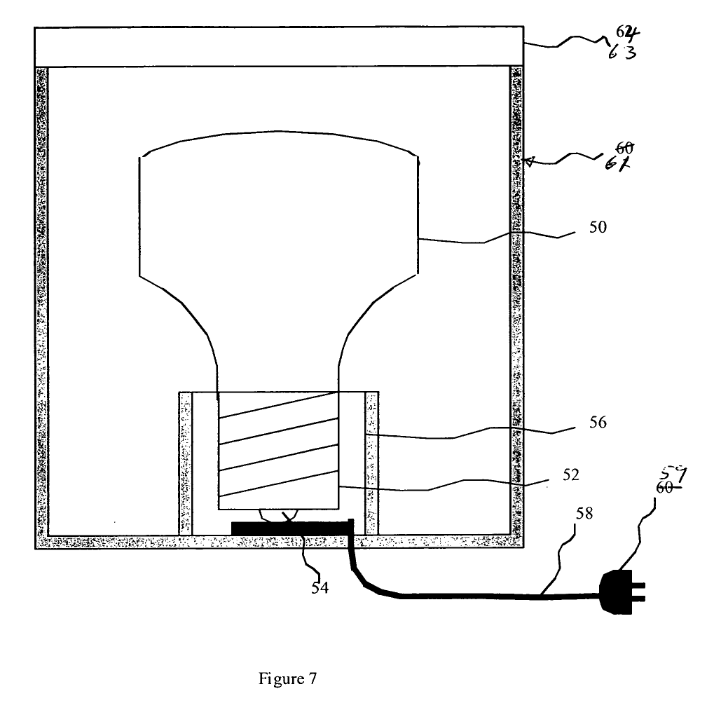

Referring to FIGS. 4 and 5, two alternative embodiments of the flat-panel area illumination device 300 and 400 made in accordance with present invention are illustrated, like numerals indicating like parts and operation as previously discussed. The flat-panel illumination device 300 of FIG. 4 illustrates the self-cleaning surface 30 provided on a support 32 laminated to the support member 20 whereas FIG. 5 illustrates a flat-panel illumination device 400 wherein the self-cleaning surface 30 is provided on encapsulating cover 22. These two designs reduce the manufacturing processing constraints on the area illumination device of the present invention by enabling the separate manufacture of the flat-panel lamp 10 and support 20 from the self-cleaning surface 30.

In application, the flat-panel area illumination devices 100, 200, 300, and 400 of the present invention may be mounted in a vertical configuration to aid the process of self-cleaning due to precipitation impinging on the self-cleaning surface 30. Referring to FIG. 6, an area illumination device is mounted on a vertical surface 40 (e.g. a brick wall). Precipitation, such as rain, falls on the surface 30 and cleans it by flowing over the surface 30 to wash away dust and dirt and by catalytically activating the surface to aid in the cleaning process. Depending on the particular construction of the illumination device, the encapsulating cover 22 or the support member 20 may be used as a mounting structure/member for mounting of the illumination system.

In a preferred embodiment, the invention is employed in an area illumination system that includes an Organic Light Emitting Diode (OLED) which is composed of small molecule or polymeric OLED materials as disclosed in but not limited to U.S. Pat. No. 4,769,292, issued Sep. 6, 1988 to Tang et al., and U.S. Pat. No. 5,061,569, issued Oct. 29, 1991 to VanSlyke et al. The light source may also include multiple light emitting layers as described in U.S. Pat. No. 6,693,296 issued Feb. 17, 2004 to Yuan-Sheng Tyan, and US Publication No. 2003/0170491 published Sep. 11, 2003 to Liao et al.

The invention has been described in detail with particular reference to certain preferred embodiments thereof, but it will be understood that variations and modifications can be effected within the spirit and scope of the invention.

### PARTS LIST

10 flat-panel lamp
12 light emitting layer(s)
14 side
16 side
18 power source
20 support member
22 encapsulating cover
24 first conductor
30 self-cleaning surface
32 support
40 vertical surface
42 aperture
50 incandescent lamp
52 base
54 electrical connection
56 socket
58 cord
59 plug
61 housing
63 protective cover
64 electrode
66 organic layer
68 electrode
100 thin-film light emitting structure
200 thin-film light emitting structure
300 thin-film light emitting structure
400 thin-film light emitting structure

What is claimed is:

1. A flat-panel organic light-emitting area illumination device, comprising:
a thin-film organic light-emitting structure comprising a first electrode, one or more organic layers including an organic light-emitting layer, and a second electrode; and
a support member having a first side and second side, said thin-film organic light-emitting structure disposed adjacent said first side, said second side having self-cleaning surface.

2. A flat-panel organic light-emitting area illumination device according to claim 1, wherein the support member is transparent, the thin-film organic light-emitting structure emits light through the support member.

3. A flat-panel organic light-emitting area illumination device according to claim 1, wherein said thin-film organic light-emitting member is secured to said support member.

4. A flat-panel organic light-emitting area illumination device according to claim 1, wherein an encapsulating cover is provided over thin-film organic light-emitting structure, said encapsulating cover is secured to said support member, said thin-film organic light-emitting structure being positioned between said encapsulating cover and said support member.

5. A flat-panel organic light-emitting area illumination device according to claim 1, wherein the encapsulating cover is transparent, the thin film organic light emitting structure emits light through the encapsulating cover.

6. A flat-panel organic light-emitting area illumination device according to claim 4, wherein said support member is transparent and has outer self-cleaning surface.

7. A flat-panel organic light-emitting area illumination device according to claim 1 wherein the support member is rigid glass.

8. A flat-panel organic light-emitting area illumination device according to claim 1, wherein the support member is flexible.

9. A flat-panel organic light-emitting area illumination device according to claim 1 wherein the support member is formed on a web.

10. A flat-panel organic light-emitting area illumination device according to claim 1, wherein the support member is formed in a continuous manufacturing process.

11. A flat-panel organic light-emitting area illumination device according to claim 1, wherein the self-cleaning surface includes a micro-structured, self-cleaning catalytically active surface with elevations and depressions, comprising a catalytically active material in the depressions.

12. A flat-panel organic light-emitting area illumination device according to claim 1, wherein the self-cleaning surface is powder coated with particles having a size of from 0.05 to 200 microns and is with a catalytically active material.

13. The area illumination device claimed in claim 1, wherein the self-cleaning surface is a super water-repellent coating film formed of a super water-repellent coating material comprising an organic coating material composed of organic polymer, a filler mixture composed of plural kinds of fillers of at least 5 nm in average particle diameter that are dispersed in the coating material, and a perfluoropolyoxyalkyl group compound

14. A flat-panel organic light-emitting area illumination device according to claim 1, wherein the flat-panel organic light-emitting area illumination device is mounted vertically.

15. A flat-panel organic light-emitting area illumination device according to claim 14, wherein the flat-panel organic light-emitting area illumination device is mounted on a substantially vertical surface outdoors and the self-cleaning surface is exposed to the environment.

16. A flat-panel organic light-emitting area illumination device according to claim 15, wherein the self-cleaning surface is cleaned by exposure to precipitation.
